(19) United States
(12) Patent Application Publication
(10) Pub. No.: US 2025/0352309 A1
(43) Pub. Date: Nov. 20, 2025

(54) Dental Alveolar Prosthesis

(71) Applicant: Italo Lozada, Weston, FL (US)

(72) Inventor: Italo Lozada, Weston, FL (US)

(21) Appl. No.: 18/665,713

(22) Filed: May 16, 2024

(51) Int. Cl. A61C 8/00

(52) U.S. Cl. CPC A61C 8/0083

(57) ABSTRACT

A dental framework is provided. The framework may be attached to a patient between bone and gums in a patient's mouth, with the framework being suited to receive one or more crowns, i.e. prosthetic teeth. The framework has a bar which receives the crown(s) and a mesh portion which allows the in-growth of soft tissue (gums).

### BACKGROUND OF THE INVENTION

The present disclosure relates generally to dental prostheses. More particularly, the present disclosure relates to a framework which can be attached to the bone of a patient under the soft tissue, and to which a crown or plurality of crowns may be attached.

Generally, the installation of a dental prosthesis replicating a tooth is performed in two steps. The first step is the installation of a bone screw into a bone of a patient. This involves drilling a hole, and then setting a screw. This screw must then set for a period of time to allow the patient's body to adapt and accept the screw, and allow new bone growth in and around the screw. Only after this time period has elapsed can a replica tooth prosthesis (commonly called a “crown”) be installed by connecting it to this now secure screw. Usually this connection is via an adhesive. This process requires a substantial amount of a dentist's time, leading to higher costs. Further, the waiting period after the screw is implanted is uncomfortable and difficult for the patient. Further still, the bone target for screw installation, which will be drilled, is often not uniform, and is difficult to estimate. As such, the drilling may easily be off, causing a misaligned screw, or worse.

Traditional crowns replicate only the tooth part that extends from the gumline. This results in issues such as lack of hygiene under the tooth at the gum line, as well as visual imperfections such as being able to view the bottom of the crown. Moreover, when a tooth is extracted, the hole left must be packed with a bone graft. If not, the soft tissue gums-which grow faster than bone, grow into the opening, preventing the space from being filled with bone growth as is preferable. Bone grafting is expensive, complex, and uncomfortable for the patient.

Moreover, unguided drilling of the implant into the bone creates a number of additional difficulties such as maintaining proper drill orientation throughout the entire drilling process. Failure to do so can cause unwanted widening of the drilled hole as well as a non-straight and non-uniform hole.

Replacement of multiple teeth, such as a full or partial denture also has a number of shortcomings including that all replacement teeth are fixed to the denture, and that gum health is negatively impacted due to inability to clean in and around the prosthesis. Further still, the appearance of these dentures may often be noticeably unnatural, leading to decreased aesthetic appeal.

Therefore, what is needed is an anchor system which may efficiently attach one or more crowns to a patient.

### SUMMARY OF THE INVENTION

The subject matter of this application may involve, in some cases, interrelated products, alternative solutions to a particular problem, and/or a plurality of different uses of a single system or article.

In one aspect, a Dental Alveolar Prosthesis formed as a dental framework is provided. The framework has a bar portion which defines a plurality of threaded openings for receiving crowns connected by threaded screws into the threaded openings. The framework further defines a dental implant opening through which an implant may pass and engage, such that an implant may be installed into the bone of the patient and join the framework to the bone. The framework further defines a porous portion made of biocompatible material. The porous portion has pores or openings, such as a mesh, which allows the growth of soft tissue through the porous portion. This allows the framework to be bio-integrated without disrupting tissue health.

In another aspect, a method of placement of a dental crown is provided. The method involves opening a flap the patient's gums and placing a framework between the gums and bones of the patient. The framework is connected to the patient by the installation of one or more implants into the bone of the patient, the implants engaging with the framework by, for example, a threaded connection, engagement of a head of the implant with the framework, and the like. Once the gums and implant placements heal, the crown may be connected to the framework using a screw, inserted through the crown, and into a threaded opening of the framework.

### BRIEF DESCRIPTION OF DRAWINGS

FIG. 1 provides an elevation view of an embodiment of the present Dental Alveolar Prosthesis.

FIG. 2 provides an elevation view of another embodiment of the present disclosure.

FIG. 3 provides a side view of an embodiment of the present disclosure.

FIG. 4 provides a side view of an embodiment of the present disclosure installed on a patient.

FIG. 5 provides a detail view of a portion of still another embodiment of the present disclosure.

FIG. 6 provides a perspective view of an embodiment of the present disclosure.

FIG. 7 provides a side view of still yet another embodiment of the present disclosure.

FIG. 8 provides a side view of an embodiment of the present disclosure installed on a patient.

FIG. 9 provides a flow chart of an embodiment of the present disclosure.

FIG. 10 provides a perspective view of still another embodiment of the present disclosure.

FIG. 11 provides a view of yet still another embodiment of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a Dental Alveolar Prosthesis which comprises a framework which may be attached to a patient between bone and gums in a patient's mouth, with the framework being suited to receive one or more crowns, i.e. prosthetic teeth. The framework has a bar which receives the crown(s) and an optional porous portion (referred to herein as a “mesh” but which may be any porous material capable of allowing in growth of soft tissue) which allows the in-growth of soft tissue (gums). The bar is formed to follow the natural outline of the teeth of a patient, to allow for a natural looking replacement crown or crowns. In typical embodiments, the bar has the traditional “horseshoe” or “U” shape of a human set of teeth, but in other embodiments may be shaped to have a partial horseshoe or U shape in embodiments where only partial tooth replacement is needed. The mesh portion supports tissue health because blood flow and healthy tissue is allowed to spread through the material and is not blocked or cut off. The framework is anchored to bone of the patient using implants, and once the implants and soft tissue heals around the framework, a crown or crowns may be directly anchored to the framework using, for example, threaded connectors, among other options. The gum tissue is generally allowed to heal over the bar portion, with the bar forming the substructure to anchor the crowns. Thus, as assembled in many embodiments, there is a layer of gum tissue between at least a portion of the crown and the framework, which allows for floss and other cleaning implements to clean all around and between the crown. This substantially improves cleaning and provides a natural appearance to the prosthesis.

The Dental Alveolar Prosthesis framework is typically formed of a frame made out of titanium, Polyetheretherketone (PEEK), or zirconium or any other biocompatible material. This base, also referred to as a “bar,” of the prosthesis is to be placed directly over the bone structure underneath the soft tissue (gums) and secured by as many implants necessary. The gums are cut open to form a flap or pocket, and then sutured back in place once installed. Once this step has been completed the framework is ready to receive the actual prosthesis, such as a crown. The connection may be performed in any suitable manner, including a screw, cement, and the like directly joining the crown with the framework and allowing soft tissue growth around the framework. In some embodiments, the crown(s) may be ready for immediate loading by virtue of their connection to the healed and secure framework, while in other embodiments additional healing time may be required. In a particular embodiment, instead of individual crowns corresponding to individual teeth, a piece corresponding to two or more teeth (partial arch) may be attached to the bar, and in a further embodiment, a single piece replicating all teeth (full arch) may be attached to the bar.

The porous portion of the bar is sufficiently porous to allow ingrowth of soft tissue. If the pores or openings are accessible to the soft tissue, the fast growing soft tissue will grow into it well before any bone is able to grow into it, thus ensuring the desired integration with soft tissue. In some embodiments, the porous portion may comprise the entire bar, such that the entire material may allow soft tissue to grow through. In other embodiments, the bar may be mostly mesh, with a solid portion making up 50% or less of the volume of the bar. This allows soft tissue to grow in and around the bar, while leaving some non-porous portion which may provide additional rigidity, an anchor for holding the crown screws and/or implants, and the like. In other embodiments, the bar may be formed of nearly all porous material (referred to as “mesh”) with solid threaded sleeves to receive the screws which anchor crowns, and solid threaded sleeves to receive the implants that anchor the bar to the bone. Notably, these threaded sleeves may be used in any embodiment. In a further embodiment, the bar may be approximately 50% or more solid (also referred to as “polished” and generally non-porous) and less than 50% mesh, with mesh or otherwise porous material on gum facing sides of the bar, such as the outer cheek-facing sides, inner tongue facing sides, teeth facing sides, and/or front side. In still further embodiments, the bar may be entirely solid without a porous portion.

The term implant and dental implant is used to refer to any device which may be anchored into the bone of a patient and is capable of anchoring another item to the bone. Common implants are used in the dental field and the implants contemplated herein may be any anchoring structure that can connect the framework to a bone of a patient. These may include prior art dental implant structures such as bone screws, customized implants, or implants not yet invented. Most commonly however, the implant is a bone screw used in dental applications.

In one embodiment, the bar base may have holes to host the implants for anchoring the framework to the bone of the patient, and other holes to connect the prosthesis (crown or crowns) to the framework. In cementing embodiments, the may be approximately uniform in shape, or may define indentations, slots, or ridges to guide placement of the crown(s).

In typical embodiments, once the surgical procedure has healed, the only portion of the structure that is showing above the gum line are the crown or crowns, because the base framework structure is underneath the gums. This provides a much better aesthetic look and functionality because flossing and other cleaning between teeth is possible. Such cleaning is important to maintain the health of the soft tissue. Also, if a prosthesis (such as a crown) needs to be replaced for whatever reason, just that prosthesis can be redone without having to replace or remove the entire assembly.

The present disclosure is, in many cases, a superior alternative to dentures. The porous mesh portion, which may cover the entirety of the framework, or only a portion thereof, is similar to a mesh or other porous material and allows for the ingrowth of soft tissue, so that blood flow can pass through and keep tissue on both sides of the framework healthy. The framework is thin, but rigid enough and big enough to be mounted to the gums while also supporting the loading experienced by the crowns once installed.

In many embodiments, the framework will have threaded holes into which screws can connect individual crowns. These screws will pass through the gums into the framework. They will be individually removable and importantly, separated so that one can floss and get in around the edges, unlike the prior art. Such embodiments allow the crown to be directly attached to the framework, and the framework in turn is directly anchored to the bone of the patient. Of course, a similar direct connection may be achieved via, for example, cement or other connector directly joining the prosthesis to framework.

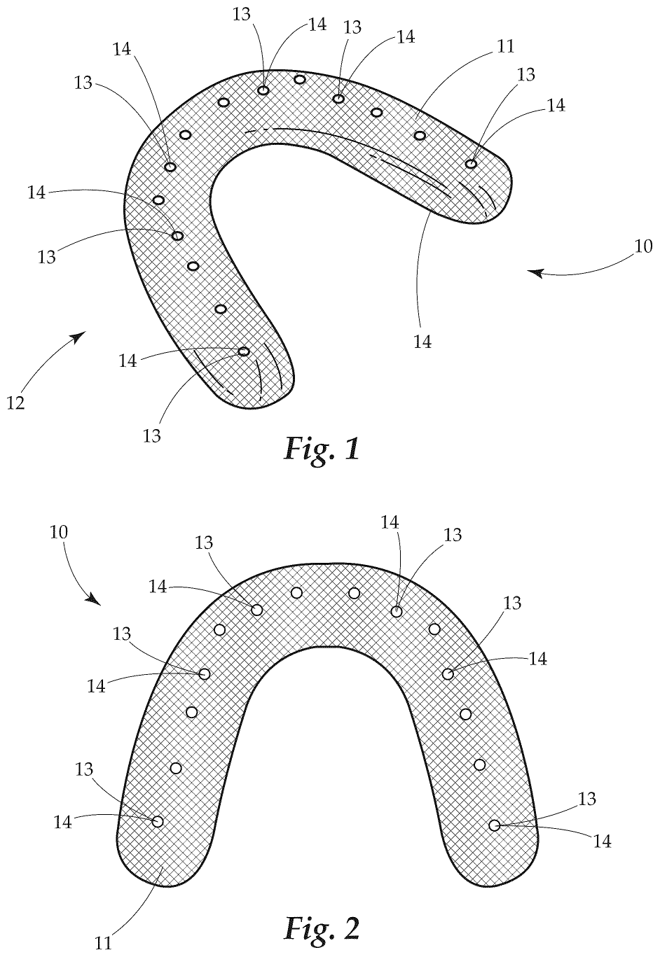

Turning now to FIGS. 1 and 2, an embodiment of the framework of the present disclosure is provided shown in elevation and perspective view. In this embodiment, the framework 10 is formed as a full denture. However, other configurations such as a partial denture may also be within the scope of this invention. The framework 10 has a horseshoe shaped bar 11 portion, which is at least partially formed of a mesh 12. The mesh may be formed of any biocompatible material that is sufficiently porous to allow soft tissue to grow through it. As noted above, the bar 11 is typically formed at least partially of the mesh 12. It should be understood that in certain embodiments, the bar 11 may have a solid, but still biocompatible material without straying from the scope of this invention. The bar 11 further defines a plurality of threaded screw holes 13 for receiving a small screw (not shown) which will anchor the crowns (not shown) to the framework 10 bar 11. In this embodiment, the implant openings 14 are positioned on the bar 11 itself along with the crown screw holes 13. In a particular embodiment, the implant openings 14 will be arranged wherever it is best suited on the patient to receive the implants. In some cases the implants may be spaced about equally across the bar 11, while in other cases, in places where a patient may have degraded bone, the implant openings 14 may be unevenly arranged to be directed to suitable areas of patient bone to receive the implant. In certain embodiments, the implant openings 14 may double as crown screw holes, such that an implant may be inserted through the implant opening, leaving a threaded area for receiving a crown screw in the same hole. In typical embodiments, the bar 11 may be designed to receive six or eight implants, though of course the number of implants may vary depending on application, patient needs, size of the bar 11, and the like. In the embodiment shown in FIG. 1, the implant openings 14 are the same as the crown screw openings 13. The crown screw and implants may have the same diameter and thread type in one embodiment, or may be different and coaxial, or a sleeve may seat in the combined crown and screw opening to accommodate for differently sized implant and crown screw.

As noted above, threaded sleeves or inserts may be fitted into the bar 11 to form the threaded holes 13 and/or openings 14, or the threads may be formed into the bar 11 itself. The implant openings 14 may be threaded to accommodate the implant, or the implant may have a head or other structure to engage with the framework while the remainder of the implant passes through the implant opening. In these views, the cross hatching is used to represent the porous mesh 12, but again it is noted that the bar 11 may have varying degrees of mesh 12 vs solid material, and that the mesh 12 may be on varying sides or faces of the bar 11, without straying from the scope of this disclosure.

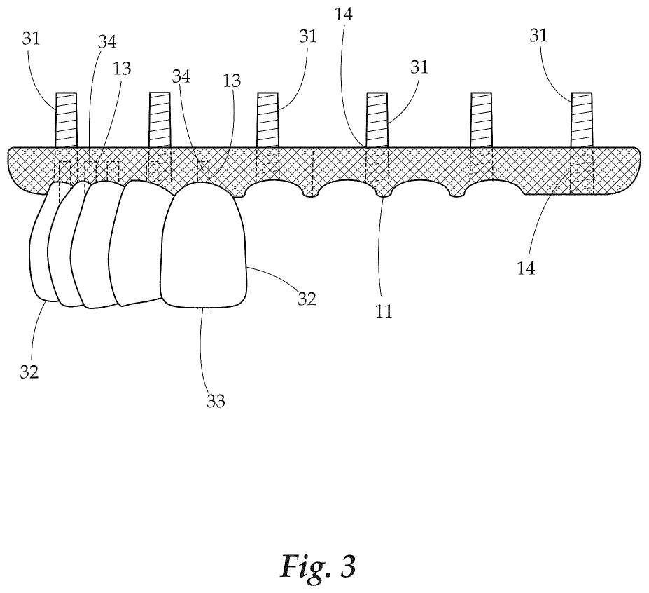

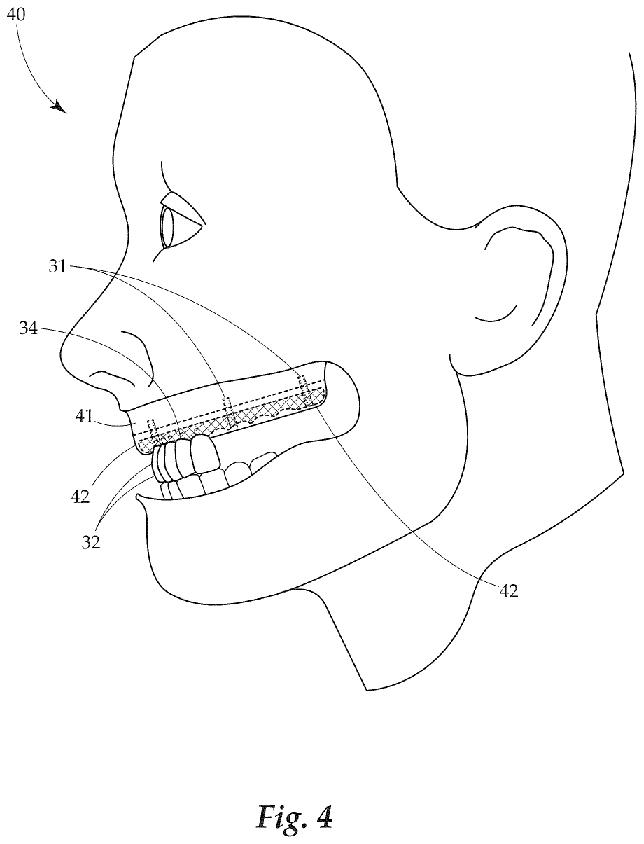

FIG. 3 shows another embodiment of a side view of the present disclosure. Here, the side of the framework 10 can be seen defining the implant openings 14 and threaded screw holes 13. Implants 31 pass through the openings and anchor the framework 10 to the bone of the patient (see FIG. 4). Crowns 32 are anchored to the framework 10 by a screw 34 passing through opening 33 and connecting crown 32 to the bar 11 portion of the framework 10. Again, this bar 11 may be porous to allow ingrowth of soft tissue, or more solid and relying on the central mesh portion (see FIG. 1) to facilitate the tissue in growth. Mesh 12 is visible on the side of the bar 11. A scalloped area is shaped on the bar 11 to receive additional crowns (not shown).

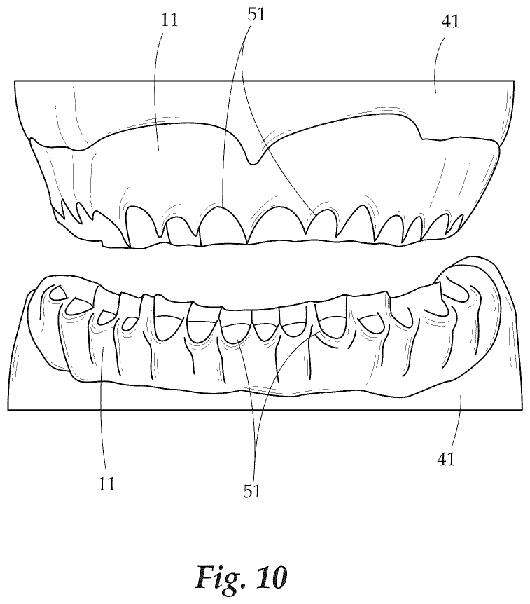

As seen in FIG. 4, the framework 10 is installed in the mouth of patient 40. Implants 31, such as those known in the art, pass through the framework 10 via implant openings 14 and anchor the framework 10 to the bone 41 of the patient 40. The gums 42 of the patient extend over the framework 10, covering it once healed. Crowns 32 are attached to the framework 10. After healing, the gum tissue 42 is opened so that a screw 34 can connect the crown 32 to the threaded screw hole 13. In certain embodiments, the threaded screw holes 13 may be filled with a plug or other removable structure so that soft tissue does not grow into these openings 13. FIG. 6 provides a detail perspective view showing the ingrowth of the gum tissue 61 into the mesh portion 12. Gums 42 are around and over the framework 10 and the crowns 32 extend from the gums as connected to the framework by, for example, a screw or other connector. As configured, the crowns 32 can be much more easily cleaned compared to the prior art and appear more realistic due to the separated crowns and natural transition between crown and living gum tissue. In this embodiment, the implant openings 14 are placed behind the crowns 32 on the bar 11. FIG. 8 provides a detail side view of the installed condition of the framework 10, having the gums 42 extending over the framework and healed, with the crowns 32 connected to the framework 10 via screws 34, through the gum tissue 42. As such, in many embodiments, there will be a gap between the bottom face of the bar 11 and a top surface of the crown 32 for the gum tissue 42 to be between the two. However, in other embodiments, the crown 32 may be directly in contact with the framework 10 bar 11. The bar 11 in this view is shown as having a mesh 12 shown in cross hatch. FIG. 10 provides a perspective view of this embodiment placed in the mouth of a patient.

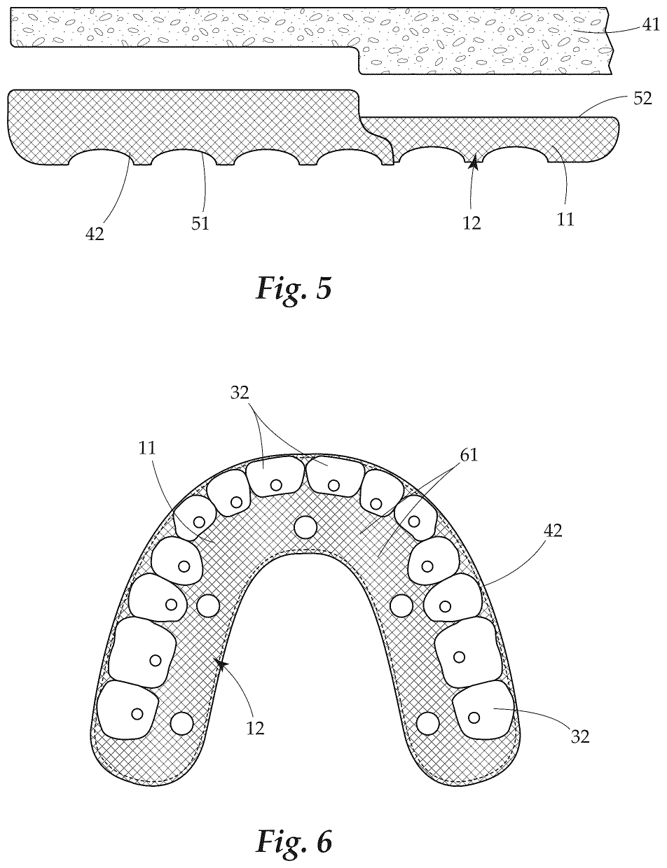

FIG. 5 provides a detail view of an embodiment of the mesh portion 12 and the bone 41 of the patient. Importantly, in this view, the varying height and configuration of the bone 41 is not smooth or consistent. This is the case in many instances. Accordingly, the framework 10 bar 11 is formed having a corresponding varying top surface 52 which matches the bone 41 and fits against it flush, or close to flush, for an effective transition and framework. Matching the shape of the top surface 52 to the bone 41 may be done in any manner, such as by taking an imprint, using a 3-D X ray or other imaging, and then forming the bar 11 to match, and the like. Scalloped recessions 51 are formed into the bar 11 and provide an area to receive a crown (not shown) which mimics the shape and appearance of natural bone and tissue.

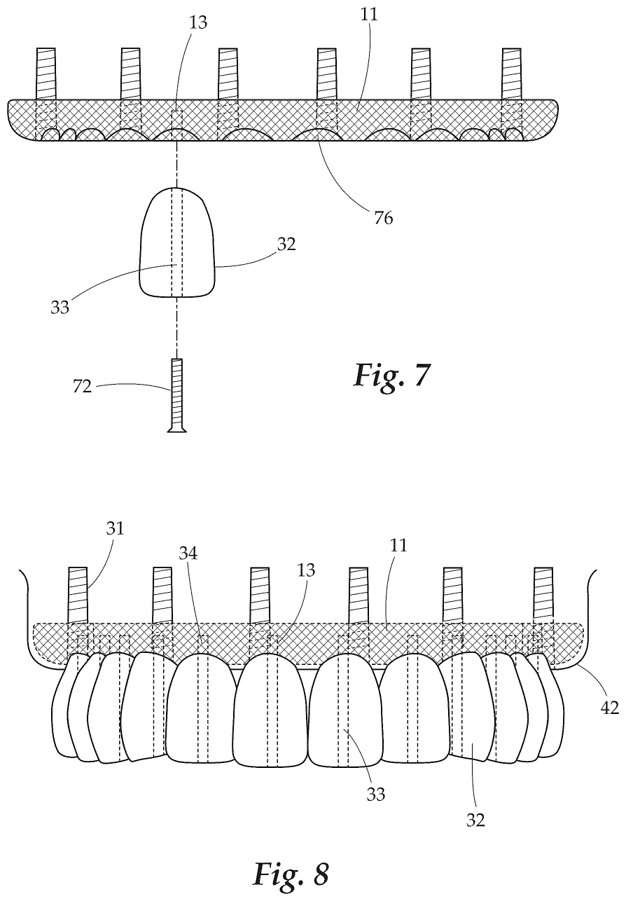

FIG. 7 provides a side view of an embodiment of the bar 11 portion of the framework. As is clear herein, the framework is largely comprised of the bar, which forms the body of the framework, and the framework as an assembly also may comprise connecting components (implant and/or crown screw), as well as crown(s). In this view, the bar forms a scalloped outer face 51 which is formed to receive a portion of the crown so that a part of the crown may fit into/against this scalloped outer face. This adds to the more natural appearance of the framework system, and may provide a more stable support for the crowns 32. In this view, the bar 11 defines scalloped recessions 51, and then a top area of crown 32 slides partially into one of these recessions 51. Crown screw 72 then passes through the crown hole 33 and into threaded opening 13 which, in this embodiment, is slightly behind the scalloped recession 51.

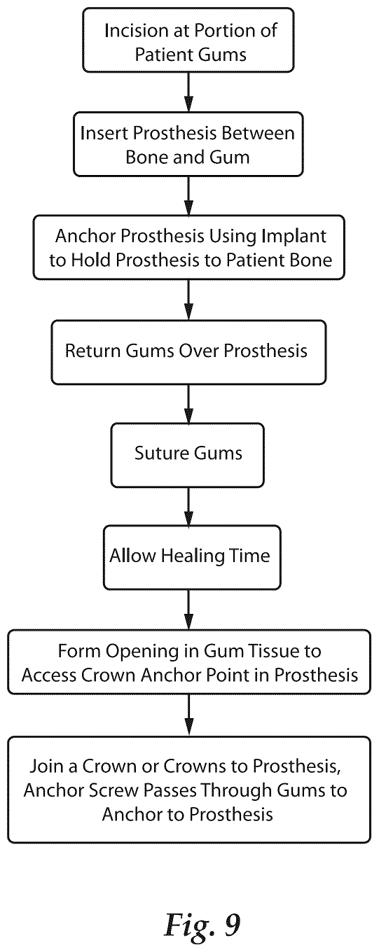

FIG. 9 provides a flow chart of an embodiment of installation of the present disclosure. The process involves making an incision at a portion of the patient's gums and then insertion of the prosthesis framework between the bone and gums. In many cases, the gum tissue is cut as a flap and pulled away. The framework is anchored to the patient bone using one or more implants which are placed into suitable bone. The gums are returned over the framework and sutured, and then the body is allowed to heal-including the gum tissue healing as well as the implants integrating into the bone. Once healed, the gum tissue may be reopened and a crown or crowns may be joined to the prosthesis by an anchor screw connecting with a threaded opening in the framework. In another embodiment, a healing cap may fit into the threaded opening(s) to allow healing of the gum tissue around the healing cap-which then allows the healing cap to be removed, and crown placed without cutting the gum tissue. The healing cap, also called a healing abutment, or gingival former can help promote soft and hard tissue healing around the framework, namely the bar.

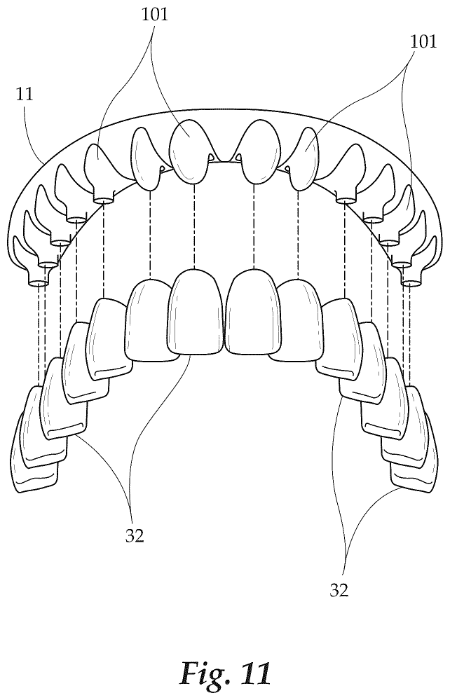

Turning to FIG. 11, an alternative embodiment of the present disclosure is provided which uses dental abutments which extend from the bar. The abutments 101 allow connection of a crown 32 directly thereto, and in turn the abutments 101 are connected to the bar 11 by either being integrally formed into the bar, connected to the bar via a frictional or adhesive connection, screwed or otherwise removably connected to the bar, and the like. Crowns 32 may be cemented or otherwise adhered to the abutments 101 in one embodiment, or may be joined to the abutment via a connector such as a screw. The bar 11 of this embodiment, functions similarly to that of the other embodiments discussed herein, in that it is typically partially or fully porous to allow ingrowth and/or over-growth of soft tissue, and is made to be anchored directly to the bone of a patient via implants passing through holes defined by the bar 11 as discussed above.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A dental framework comprising:
a bar portion, the bar portion defining a plurality of threaded openings;
a dental implant opening through which an implant may pass; and
wherein the framework defines a porous portion of biocompatible material into which soft tissue may grow.

2. The dental framework of claim 1 wherein the bar portion defines a full denture or a partial denture, and wherein the porous portion extends away from the bar portion.

3. The dental framework of claim 1 wherein the bar portion is formed of a porous biocompatible material into which soft tissue may grow.

4. The dental framework of claim 1 further comprising an implant screw engaged with the dental implant opening.

5. The dental framework of claim 1 further comprising a plurality of dental crowns, each of the plurality of crowns attached by a threaded screw into one of the plurality of threaded openings.

6. The dental framework of claim 4 further comprising a plurality of dental crowns, each of the plurality of crowns attached by a threaded screw into one of the plurality of threaded openings.

7. The dental framework of claim 5 wherein each of the plurality of dental crowns are spaced apart from the bar by a gap allowing gum tissue to grow in between.

8. The dental framework of claim 5 wherein each of the plurality of dental crowns directly contact the bar at a top surface of each crown.

9. The dental framework of claim 1 wherein the bar portion defines a horseshoe shape for a full denture.

10. The dental framework of claim 1 wherein the dental implant opening is formed through the bar portion through a top and bottom of the bar portion.

11. The dental framework of claim 4 wherein the dental implant opening is formed through the bar portion through a top and bottom of the bar portion.

12. The dental framework of claim 1 wherein the dental implant opening is formed on the porous portion.

13. The dental framework of claim 4 wherein the dental implant opening is formed on the porous portion.

14. The dental framework of claim 1 wherein the bar and porous portion are formed of one of titanium, Polyetheretherketone (PEEK), or zirconium.

15. The dental framework of claim 1 wherein the bar defines a plurality of scalloped recessions.

16. The dental framework of claim 15 further comprising a plurality of dental crowns, each of the plurality of crowns attached by a threaded screw into one of the plurality of threaded openings, and each of the plurality of crowns engaged with one of the scalloped openings.

17. A method of placement of a dental crown comprising the steps of:
cutting a portion of a patient's gums;
placing a framework between the gums and bone of the patient;
connecting the framework to the patient by installing one or more implants;
attaching the crown to the framework using a screw inserted into a threaded opening of the framework.

18. The method of claim 17 wherein the framework comprises a porous portion.

19. The method of claim 17 wherein the step of installing the one or more implants comprises engaging the implant with the framework via threaded engagement or a head of the implant engaging with a portion of the framework.

20. The method of claim 17 wherein the step of attaching the crown to the framework comprises cutting open the gums to access the threaded opening of the framework, or removing a healing cap from the threaded opening of the framework.
